(19) United States
(12) Patent Application Publication
(10) Pub. No.: US 2026/0292395 A1
(43) Pub. Date: Sep. 24, 2026

(54) WEARABLE AUDIO DEVICE INCLUDING AN IMPROVED EAR CUP

(71) Applicant: BOSE CORPORATION, Framingham, MA (US)

(72) Inventors: Ole Mattis NIELSEN, Cambridge (GB); John Harlan WENDELL, Boston, MA (US); Amar G. BOSE, Framingham, MA (US)

(21) Appl. No.: 19/084,626

(22) Filed: Mar. 19, 2025

(51) Int. Cl. H04R 1/28; H04R 29/00

(52) U.S. Cl. CPC H04R 1/288; H04R 29/002; H04R 2201/02

(57) ABSTRACT

A wearable audio device is described. An ear cushion interface surface surrounds a cavity. A driver housing is disposed in a base surface of the cavity. The driver housing is shaped to house a driver. Sound damping material is disposed in the cavity at least partially covering the base surface and at least partially filling the cavity. The sound damping material includes a driver cutout at least partially surrounding the driver housing. The driver cutout defines a driver volume between the driver housing and a top surface of the sound damping material. A height of the top surface of the sound damping material in the area defining the driver cutout is at least halfway between the base surface of the cavity and the ear cushion interface surface.

### BACKGROUND

The present disclosure generally relates to a wearable audio device including an improved ear cup. Wearable audio devices typically emit sound from an ear cup at a location close to, around, or on a user’s ear.

### SUMMARY

All examples and features mentioned below can be combined in any technically possible way.

Aspects of the present disclosure provide a wearable audio device. The wearable audio device includes an ear cup the ear cup body including an ear cushion interface surface, a cavity, a driver housing, and sound damping material. The ear cushion interface surface surrounds the cavity. The driver housing is disposed in a base surface of the cavity. The driver housing is shaped to house a driver configured to emit sound. The sound damping material is disposed in the cavity at least partially covering the base surface and at least partially filling the cavity. The sound damping material includes a driver cutout at least partially surrounding the driver housing. The driver cutout defines a driver volume between the driver housing and a top surface of the sound damping material. A height of the top surface of the sound damping material in the area defining the driver cutout is at least halfway between the base surface of the cavity and the ear cushion interface surface.

In aspects, the sound damping material includes a varying thickness in the area defining the driver cutout.

In aspects, the driver cutout at least partially conforms to a circumferential shape of the driver.

In aspects, the driver is circular and the driver cutout is at least partially circular.

In aspects, the driver is circular and the driver cutout is circular.

In aspects, the driver cutout comprises a diameter equal to a diameter of the driver.

In aspects, the driver volume is at least partially cylindrical.

In aspects, the driver cutout surrounds the driver.

In aspects, wherein the driver cutout includes a side wall and the side wall is perpendicular to a plane defined by the ear cushion interface surface.

In aspects, the driver housing is not covered by an acoustically resistive material.

In aspects, the driver volume does not include an acoustically resistive material.

In aspects, there is no acoustically resistive material disposed between the driver housing and the ear cushion interface surface.

In aspects, a feedback microphone is disposed within the driver volume, wherein the feedback microphone is not covered by an acoustically resistive material.

In aspects, a height of the top surface of the sound damping material is coplanar with a plane defined by the ear cushion interface surface.

In aspects, a height of the top surface of the sound damping material is, at a maximum, co-planar with a plane defined by the ear cushion interface surface, the driver cutout includes a side wall that is perpendicular to the plane defined by the ear cushion interface surface, and a cross-section of the driver volume at least partially conforms to a circumferential shape of the driver as projected onto the plane defined by the ear cushion interface surface.

In aspects, there is no acoustically resistive material between the driver housing and the ear cushion interface surface.

In aspects, the circumferential shape of the driver as projected onto the plane defined by the ear cushion interface surface is a circle or an oval, and wherein the cross-section of the driver volume is a circle or an oval.

In aspects, a height of the top surface of the sound damping material is within about 2.5mm of the ear cushion interface surface.

In aspects, the sound damping material is acoustically open below a frequency of about 1kHz and damps sound above a frequency of about 1kHz.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 illustrates an exemplary wearable audio device, according to one or more aspects.

FIG. 2 illustrates an ear cup of the wearable audio device of FIG. 1, according to one or more aspects.

FIG. 3A illustrates an isometric view of the ear cup of FIG. 2 with the ear cushion removed, according to one or more aspects.

FIG. 3B illustrates a cross-sectional view of the ear cup of FIG. 2 with the ear cushion removed, according to one or more aspects.

FIG. 4 illustrates an isometric view of another ear cup with the ear cushion removed, according to one or more aspects.

FIG. 5 illustrates top and side views of embodiments of the sound damping material, according to one or more aspects.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In aspects, the disclosure contemplates that terms such as “couples,” “coupling,” “couple,” and “coupled” may include but are not limited to, interference fitting, magnetic fastening, interlocking coupling, adhesively coupling, pinned coupling. In aspects, the disclosure contemplates that terms such as “couples,” “coupling,” “couple,” and “coupled” may include but are not limited to integrally forming. In aspects, the disclosure contemplates that terms such as “couples,” “coupling,” “couple,” and “coupled” may include but are not limited to direct coupling and/or indirect coupling, such as indirect coupling through intermediate components.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the headphones herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Aspects of the present disclosure provide systems, apparatus, and methods regarding a wearable audio device having an ear cup body and sound damping material. The ear cup body includes a cavity and a driver housing disposed in a base surface of the cavity. The sound damping material is disposed in the cavity and at least partially covers the base surface and at least partially fills the cavity. The sound damping material further includes a driver cutout at least partially surrounding the driver housing and the driver cutout defines a driver volume between the driver housing and the top surface of the sound damping material.

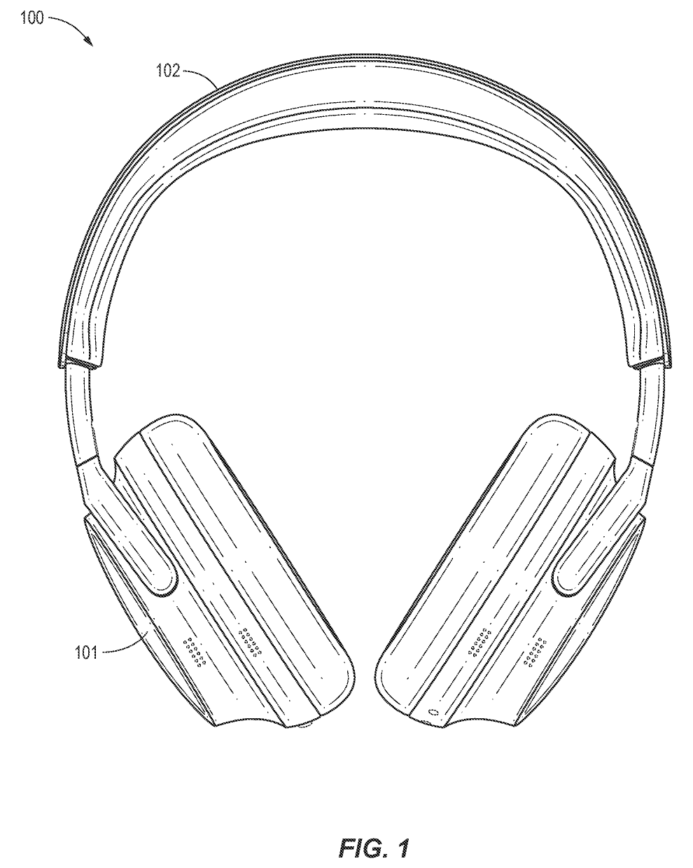

FIG. 1 illustrates an exemplary wearable audio device 100. In one or more embodiments, the wearable audio device 100 is an active noise reduction (ANR) headset 100. The wearable audio device 100 includes one or more ear cups 101. The ear cups 101 are sized and shaped to fit on, over, or around a user’s ear so that a user may wear the wearable audio device 100 such that the wearable audio device 100 can emit sound at a location close to, around, or on a user’s ear. In one or more embodiments, the wearable audio device 100 further includes a strap 102 that may connect the one or more ear cups 101. The strap 102 may also secure the wearable audio device 100 to a user’s body, such as a user’s head, so that the wearable audio device 100 remains in place during use.

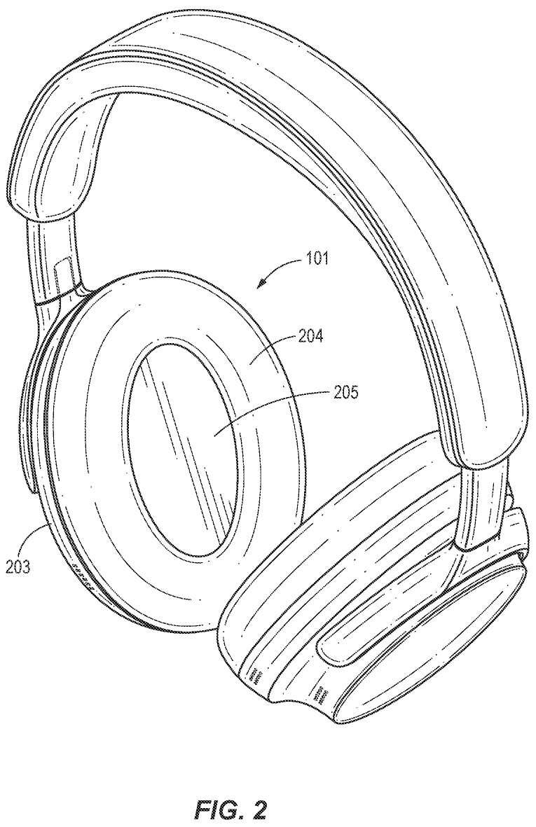

FIG. 2 illustrates the ear cup 101 of the wearable audio device 100 of FIG. 1. The ear cup 101 includes an ear cup body 203 and an ear cushion 204. The ear cup body 203 is at least partially hollow and contains hardware and circuitry for emitting and controlling sound. The ear cushion 204 is removably coupled to the ear cup body 203 and is used as an interface between the user’s head and/or ear and the ear cup body 203. According to one non-limiting example, the ear cushion 204 can be disposed around the user’s ear. In one or more embodiments the ear cushion 204 is compressible such that when the ear cup 101 is secured to the user’s head, the ear cushion 204 compresses to move the ear cup body 203 closer to the user’s ear and so that the user is comfortable when the wearable audio device 100 is secured to the user’s head. The ear cushion 204 may be annular such that the ear cushion 204 is disposed around the user’s ear and the opening in the center of the cushion 204 surrounds the user’s ear. Thus, the ear cushion 204 is against the user’s head and the user’s ear is disposed inside of the opening formed by the annular ear cushion 204. A separator 205 may be disposed within the opening formed by the annular ear cushion 204. In one or more embodiments, the separator 205 is a cloth material. The separator 205 acts as a physical barrier between in interior of the ear cup body 203 and the user’s ear. In one or more embodiments, the separator 205 is also acts as a sound modifier to improve acoustics emitted from the interior of the ear cup body 203.

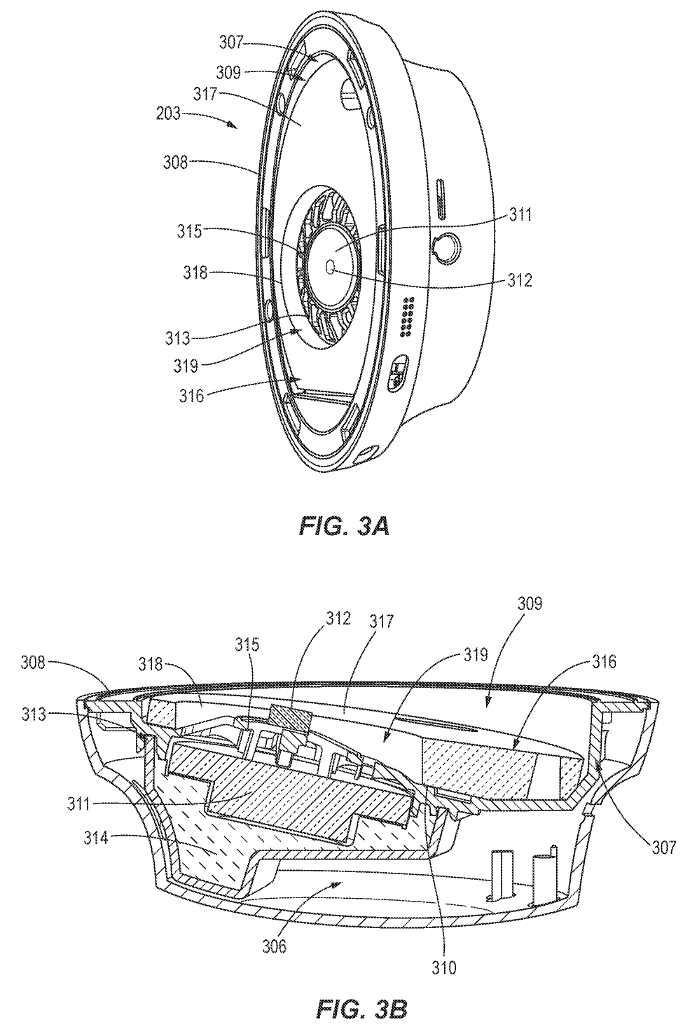

FIGS. 3A-3B illustrate the ear cup 101 with the ear cushion 204 removed. FIG. 3A is an isometric view of the ear cup 101 with the ear cushion 204 removed. FIG. 3B is a cross-sectional view of the ear cup 101 with the ear cushion 204 removed. The ear cup body 203 includes a hollow interior 306 and a driver plate 307. The hollow interior 306 houses or at least partially houses the hardware and circuitry configured to emit and control sound. The driver plate 307 is disposed in the hollow interior 306 and includes an ear cushion interface surface 308 and a cavity 309. The ear cushion interface surface 308 is a flat or substantially flat surface to which the ear cushion 204 attaches. The cavity 309 is formed by the driver plate 307, includes a base surface 310, and is surrounded by the ear cushion interface surface 308. In one or more embodiments, such as the one illustrated, the base surface 310 of the cavity 309 is not parallel to the ear cushion interface surface 308.

The hardware and circuitry configured to emit sound includes a driver 311 and a microphone 312. In one or more embodiments, the microphone 311 is disposed in front of the driver 311 (i.e., between the driver 311 and the ear cushion interface surface 308). The driver 311 is configured to emit sound towards the user’s ear. The microphone 312 may be a feedback microphone and may be used for active noise cancelling and for controlling sound for improved audio quality.

The driver 311 is disposed in a driver housing 313 disposed within the hollow interior 306 of the ear cup body 203. In one or more embodiments, the driver housing 313 is at least partially disposed in the base surface 310 of the cavity 309. In one or more embodiments, the driver housing 313 includes a driver mount 314 and a driver retaining feature 315. The driver 311 is disposed in the driver mount 314 and retained in the driver mount 314 by the driver retaining feature 315. In one or more embodiments, the driver retaining feature 315 may be a portion of, or integral to, the driver plate 307.

In one or more embodiments, the microphone 312 is coupled to the driver housing 313. For example, in one or more embodiments, such as the illustrated embodiment, the microphone 312 is coupled to the driver retaining feature 315.

The ear cup 101 further includes sound damping material 316 disposed in the cavity 309. In one or more embodiments, the sound damping material 316 may be a compressible material, such as a foam. In one or more embodiments, the sound damping material 316 acts as acoustically open at low frequencies (e.g., below about 1kHz) but at a higher frequency (e.g., above about 1kHz), the sound damping material 316 acts to insulate, deaden, and/or damp sound. The sound damping material 316 at least partially covers the base surface 310 and at least partially fills the cavity 309. In one or more embodiments, the sound damping material 316 covers the entirety of the base surface 310 other than the driver 311, driver housing 313, and other sound emitting hardware (e.g., ports, such as a pressure equalizing port). In one or more embodiments, the sound damping material 316 fills the entirety of the cavity 309 other than the driver volume (as discussed later) and other sound emitting hardware.

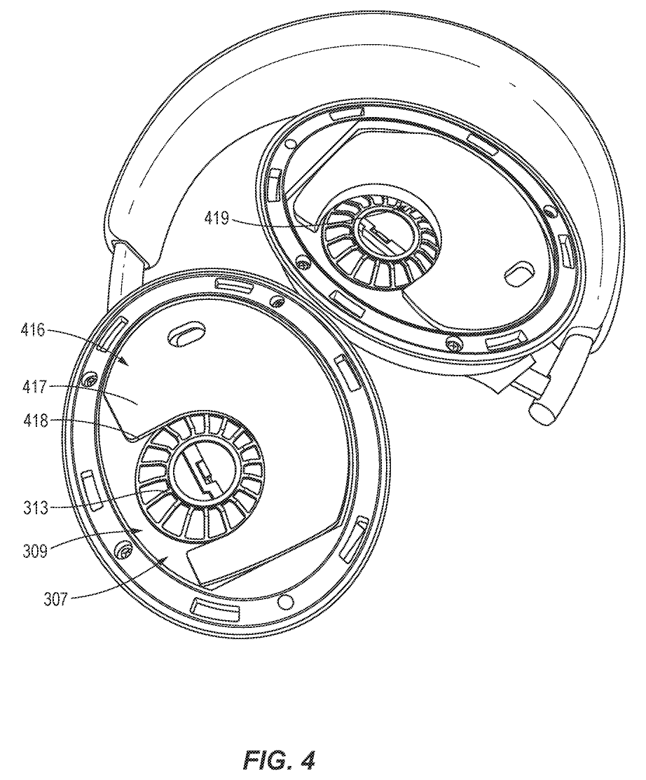

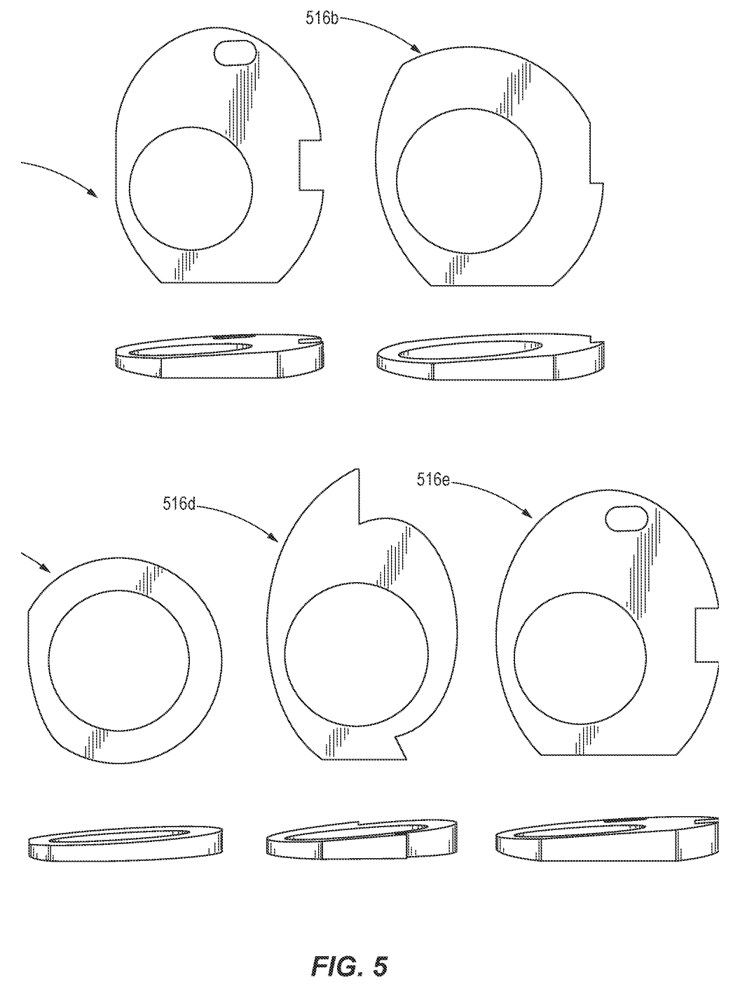

The sound damping material 316 acts to improve acoustics by not only providing more damping in the cavity 309 by also by reducing reactive fields in the cavity 309 to better couple the sound emitting and controlling hardware (e.g. the driver 311 and the microphone 312, e.g., “the hardware”) and the user’s ear. Further, feedback loops for sound control, such as active noise reduction (ANR), may be improved by the sound damping material 316 due to the reduced reactive fields and damping in the cavity 309. Without being bound by theory (and as further discussed below) the sound damping material 316 reduces reactive fields and better couples a user’s ear to the hardware by reducing the empty space in which the hardware may emit and receive sound. In one or more embodiments, the empty space is reduced by surrounding said hardware with a sound damping material 316 of a sufficient thickness to create a driver volume 319 extending from the hardware to as close to the user’s ear as possible. The driver volume 319 better couples the hardware and the user’s ear and reduces reactive fields. In one or more embodiments, as shown in FIGS. 3A-4, the sound damping material 316 may fill, or almost fill, the cavity 309 in creating the driver volume 319. In one or more embodiments, as shown in FIG. 5 with respect to sound damping materials 516b and 516c, the sound damping material 316 is only locally surrounds the hardware (i.e., the increased thickness only surrounds the sound emitting and controlling hardware). In any event, the empty space surrounding the hardware is minimized by the sound damping material 316 thereby reducing reactive fields and improving coupling between the user’s ear and the hardware.

The top surface 317 of the sound damping material 316 has a height wherein the top surface 317 is, at most, co-planar with the ear cushion interface surface 308. The height of the sound damping material 316 being at most co-planar with the ear cushion interface surface 308 prevents the sound damping material 316 from interfering with the assembly of the remaining components of the ear cup 101 and maximizes the amount of sound damping material 316 that may be put into the cavity 309. In one or more embodiments, the height of the sound damping material 316 is coplanar with the ear cushion interface surface 308. In one or more embodiments, the height of the sound damping material 316 extends at least one eighth of the way (e.g., at least a quarter of the way, at least halfway, at least three quarters of the way) between the base surface 310 of the cavity 309 and the user’s ear. In one or more embodiments, the height of the sound damping material 316 extends at one eighth of the way (e.g., at least a quarter of the way, at least halfway, at least three quarters of the way) between the base surface 310 of the cavity 309 and the ear cushion interface surface 308. In one or more embodiments, the height of the sound damping material 316 is between about 0 mm and about 2.5mm from being co-planar with the ear cushion interface surface 308. In one or more embodiments, a localized area of the sound damping material 316 (e.g., the area defining the driver cutout 318 as discussed below) is at a maximum coplanar with the ear cushion interface surface 308 and is at least one eighth of the way (e.g., at least a quarter of the way, at least halfway, at least three quarters of the way) between the base surface 310 of the cavity 309 and the user’s ear and/or the base surface 310 of the cavity 309 and the ear cushion interface surface 308.

In embodiments where the base surface 310 is not parallel to the ear cushion interface surface 308, the sound damping material 316 may have a varied thickness to maximize the amount of sound damping material 316 that may be installed into the cavity 309. In some embodiments, the varied thickness is localized (e.g., in the area defining the driver cutout 318 as discussed below). Similarly, in one or more embodiments, the top surface 317 may be parallel to the ear cushion interface surface 308. Accordingly, in one or more embodiments, the top surface 317 may be not parallel to the base surface 310 or the bottom surface of the sound damping material 316.

The sound damping material 316 further includes a cutout 318. The cutout 318 is shaped complementary to the circumferential shape of the driver 311. In one or more embodiments, the cutout 318 and the driver 311 are substantially the same shape. In one or more embodiments, the cutout 318 conforms to the shape of the driver 311 as projected onto a plate defined by the ear cushion interface surface 308. As one example, the driver 311 is circular and the cutout 318 is also circular. In one or more embodiments, the cutout 318 has the same circumferential shape as the driver 311 with the same outer dimensions. For example, as illustrated in FIG. 3A, the driver 311 and driver housing 313 are circular and the cutout 318 is circular with the same diameter. In one or more embodiments, the dimensions of the circumferential shape of the cutout 318 are within 25mm of the circumferential shape of the driver 311. As an example, the dimensions of the circumferential shape of the cutout 318 may be within 20mm, 15mm, 10mm, 5mm, 1mm, or 0mm of the circumferential shape of the driver 311. In one or more embodiments, the area of the cutout 318 is, at most, 150% of the area of the circumferential shape of the driver 311. As an example, the area of the cutout 318 may be within 125%, 110%, 105%, or 100% of the area of the circumferential shape of the driver 311.

The cutout 316 creates a driver volume 319 defined by the top surface 317 of the sound damping material 316, the cutout 318, and the top of the driver housing 313. The driver volume 319 directs sound from the driver 311 to a user’s ear. The cross-sectional shape of the driver volume 319 is at least partially the shape of the cutout 318. In one or more embodiments, the cutout 318 completely surrounds the driver housing 313 such that the cross-sectional shape of the driver volume 319 is the shape of the cutout 318. As an example, the cutout 318 may be circular and the driver volume 319 may be cylindrical.

In one or more embodiments, the cutout 318 doesn’t entirely surround the driver 311. Accordingly, the cross-sectional shape of the driver volume 319 is only partially the shape of the cutout 318. For example, FIG. 4 illustrates another embodiment of the sound damping material 416 including cutout 418 that is complementary to the circumferential shape of the driver 311 but the cutout 418 does not completely surround the driver 311. Thus, in such embodiments, the driver volume 419 is partially defined by the top surface 417 of the sound damping material 416, the cutout 418, the driver plate 307, and the top of the driver housing 313.

In one or more embodiments, the side walls of the cutout 318 are perpendicular to a plane defined by the ear cushion interface surface 308. Accordingly, the cross-section of the driver volume 319 at least partially conforms to the circumferential shape of the driver 311 as projected onto a plane defined by the ear cushion interface surface 308.

In one or more embodiments, the side walls of the cutout 318 are perpendicular to a plane defined by the base surface 310 of the cavity 309. Accordingly, the cross-section of the driver volume 319 at least partially conforms to the circumferential shape of the driver 311 as projected onto a plane defined by the base surface 310 of the cavity 309.

In one or more embodiments, the side walls of the cutout 318 are perpendicular to a plane defined by the top surface 317 of the sound damping material 316. Accordingly, the cross-section of the driver volume 319 at least partially conforms to the circumferential shape of the driver 311 as projected onto a plane defined by the top surface 317 of the sound damping material 316.

In one or more embodiments, an acoustically resistive material, such as a mesh or metal mesh is not necessarily needed to cover the driver 311 and/or the microphone 312 due to improved acoustics resulting from the sound damping material 316. As an example, in one or more embodiments, an acoustically resistive material, such as a mesh or a metal mesh, is not disposed between the driver housing 313 and the top surface 317 of the sound damping material 316. In other words an acoustically resistive material, such as a mesh or a metal mesh, is not disposed in the driver volume 319. As another example, in one or more embodiments, an acoustically resistive material, such as a mesh or a metal mesh, is not disposed between the driver housing 313 and the ear cushion interface surface 308. As another example, in one or more embodiments, an acoustically resistive material, such as a mesh or a metal mesh, is not disposed between the driver housing 313 and the ear cushion interface surface 308.

FIG. 5 illustrates top and side views of embodiments of the sound damping material 516a, 516b, 516c, 516d, 516e. As shown in FIG. 5, the shape and size of the sound damping material 516a, 516b, 516c, 516d, 516e may vary.

For example, in one or more embodiments, as illustrated as sound damping materials 516a, 516d, and 516e, the sound damping material may be shaped to substantially fill the ear cup and, thus, must include extra cut-outs for the geometry of the ear cup and/or other features of other sound emitting hardware (e.g., ports, such as a pressure equalizing port). In other words, the outer diameter of the sound damping material may conform to the sidewalls of the cavity of the ear cup. Still, in one or more embodiments, such as those illustrated as sound damping materials 516b and 516c, the sound damping material may be shaped to maximize the sound damping material around the driver cutout but minimize sound damping material elsewhere in the ear cup.

Also, the thickness of the sound damping material may vary. For example, while the general shapes are the same, the thickness of sound damping material 516a may be slightly larger than the thickness of sound damping material 516b.

Any one or more components of the wearable audio device 100 may be integrally formed together, directly coupled together, and/or indirectly coupled together and are not limited to the specific arrangement of components illustrated in FIGS. 1-4. Any one or more of the components or embodiments of the wearable audio device 100 may be combined in whole or part with any other components or embodiments of the wearable audio device 100.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A wearable audio device, comprising:
an ear cup body including:
an ear cushion interface surface configured to removably couple an ear cushion to the ear cup body, wherein the ear cushion is shaped to surround a user’s ear;
a cavity, wherein the ear cushion interface surface surrounds the cavity; and
a driver housing, wherein the driver housing is disposed in a base surface of the cavity, and wherein the driver housing is shaped to house a driver configured to emit sound; and
sound damping material disposed in the cavity at least partially covering the base surface and at least partially filling the cavity, wherein:
the sound damping material includes a driver cutout at least partially surrounding the driver housing;
the driver cutout defines a driver volume between the driver housing and a top surface of the sound damping material; and
a height of the top surface of the sound damping material in the area defining the driver cutout is at least halfway between the base surface of the cavity and the ear cushion interface surface.

2. The wearable audio device of claim 1, wherein the sound damping material includes a varying thickness in the area defining the driver cutout.

3. The wearable audio device of claim 1, wherein the driver cutout at least partially conforms to a circumferential shape of the driver.

4. The wearable audio device of claim 3, wherein the driver is circular and the driver cutout is at least partially circular.

5. The wearable audio device of claim 3, wherein the driver is circular and the driver cutout is circular.

6. The wearable audio device of claim 5, wherein the driver cutout comprises a diameter equal to a diameter of the driver.

7. The wearable audio device of claim 1, wherein the driver volume is at least partially cylindrical.

8. The wearable audio device of claim 1, wherein the driver cutout surrounds the driver.

9. The wearable audio device of claim 1, wherein the driver cutout includes a side wall, and wherein the side wall is perpendicular to a plane defined by the ear cushion interface surface.

10. The wearable audio device of claim 1, wherein the driver housing is not covered by an acoustically resistive material.

11. The wearable audio device of claim 1, wherein the driver volume does not include an acoustically resistive material.

12. The wearable audio device of claim 1, wherein there is no acoustically resistive material disposed between the driver housing and the ear cushion interface surface.

13. The wearable audio device of claim 1, further comprising a feedback microphone disposed within the driver volume, wherein the feedback microphone is not covered by an acoustically resistive material.

14. The wearable audio device of claim 1, wherein a height of the top surface of the sound damping material is coplanar with a plane defined by the ear cushion interface surface.

15. The wearable audio device of claim 1, wherein:
a height of the top surface of the sound damping material is, at a maximum, co-planar with a plane defined by the ear cushion interface surface;
the driver cutout includes a side wall that is perpendicular to the plane defined by the ear cushion interface surface; and
a cross-section of the driver volume at least partially conforms to a circumferential shape of the driver as projected onto the plane defined by the ear cushion interface surface.

16. The wearable audio device of claim 15, wherein there is no acoustically resistive material between the driver housing and the ear cushion interface surface.

17. The wearable audio device of claim 15, wherein the circumferential shape of the driver as projected onto the plane defined by the ear cushion interface surface is a circle or an oval, and wherein the cross-section of the driver volume is a circle or an oval.

18. The wearable audio device of claim 1, wherein a height of the top surface of the sound damping material is within about 2.5 mm of the ear cushion interface surface.

19. The wearable audio device of claim 1, wherein the sound damping material is acoustically open below a frequency of about 1kHz and damps sound above a frequency of about 1kHz.
